(19) United States
(12) Patent Application Publication
(10) Pub. No.: US 2025/0279665 A1
(43) Pub. Date: Sep. 4, 2025

(54) System for Automatically Charging Spaced-Apart Devices

(71) Applicant: Cronopower LLC, Broomfield, CO (US)

(72) Inventors: Gary F. Skinner, Broomfield, CO (US); John J. MacKenzie, Wheat Ridge, CO (US)

(73) Assignee: Cronopower LLC, Broomfield, CO (US)

(21) Appl. No.: 18/891,325

(22) Filed: Sep. 20, 2024

Related U.S. Application Data
(60) Provisional application No. 63/560,030, filed on Mar. 1, 2024.

(51) Int. Cl. H02J 7/00

(52) U.S. Cl. CPC H02J 7/0071; H02J 7/00047; H02J 7/0025; H02J 7/0049; H02J 7/00712; H02J 2207/20; H02J 2207/50

(57) ABSTRACT

A system for automatically charging energy storage devices associated with spaced-apart apparatuses includes a system power supply connected to a power hub, a power bus for providing power from the power hub to the energy storage devices, and charging taps for drawing power from the bus and charging the devices. Charging taps are continuously powered and may connect to a single device or more than one device. Generally only one energy storage device is charged at a time.

### BACKGROUND OF THE INVENTION

### Field of the Invention

The present invention relates to apparatus and methods for automatically charging batteries or supercapacitors in spaced-apart devices. These devices typically have built-in energy storage so they can operate during a power outage. In particular, the present invention relates to charging energy storage items in motors for motorized window treatments. Other applications include emergency lighting and smoke detectors.

### Discussion of Related Art

Motorized window treatments are often operated by battery powered motors. The window treatments tend to be spread out over a building and often have different motors with different charging requirements, as the windows may have different sizes and coverings. Currently, the motors are manually charged with plug in power supplies and require human intervention. Currently, motors are not using supercapacitors as they must be charged too often. Smoke detectors typically use primary cells that must be replaced yearly.

### SUMMARY OF THE INVENTION

A system for automatically charging energy storage devices located at or within spaced-apart apparatuses includes a system power supply connected to a power hub, a power bus for providing power from the power hub to the energy storage devices, and charging taps for drawing power from the bus and charging the devices. Charging taps are continuously powered and may connect to a single device or more than one device.

A connecting cable may be connected between the charging tap and the device, and include a resistive jumper that tells the tap how much voltage and current the device needs to charge. This allows the system to be used with various devices that require different charging voltages or currents.

The tap has a timer for each device attached to the tap. When the timer expires, the tap determines whether the bus is free to charge the apparatus's energy storage device or if the bus is already in use. If the bus is available, the tap marks the bus as busy and converts the bus power to what the apparatus's energy storage device needs. The energy storage device is charged for a fixed amount of time, or alternatively until the associated device stops drawing current. Then the tap removes power from the energy storage device and resets the timer to schedule the next charge. The bus is now free to charge another device.

Alternately, the tap could communicate with the device, or be built into the device and then have knowledge of the battery state of charge, and only charge when needed.

Alternately, the tap could have a built-in energy storage device like a supercapacitor which is then used to run a DC powered device that does not have an internal battery. The tap can then monitor the state of charge of the storage device and charge as needed. Again, this could be built in to the device.

A system for automatically charging spaced-apart energy storage devices includes a power hub connected to a system power supply, a plurality of energy storage devices to be charged, the energy storage devices spaced apart from each other, a bus for distributing power from the power hub, charging taps located at the energy storage devices and connected to the bus and to the energy storage devices, the charging taps configured to draw power from the bus and to charge the energy storage devices.

Each charging tap includes a processor including a timer configured to determine when an associated energy storage device is to be charged and the system is configured such that only a subset of the energy storage devices is charged at the same time. Usually only one energy storage device is charged at a time. Identifying mechanisms may be connected to each built-in energy storage device to determine the power requirements of that built in energy storage device. Then the charging taps provide power configured according to associated identifying mechanisms.

Some of the energy storage devices and their charging taps are built into their apparatuses. Some energy storage devices may located within charging taps and power their apparatuses from there. Some energy storage devices may located within apparatuses, discrete from charging taps.

The processors may further include a bus-check mechanism configured to check whether the bus is in use when a timer indicates an energy storage device is to be charged, and to delay charging that energy storage device if the bus is in use. Each timer may have a programmed time slot charging occurs during that time slot.

Usually each charging tap is connected to only one or two apparatuses.

The energy storage devices may comprise batteries or capacitors. The energy storage devices are not necessarily all similarly configured. In some cases the apparatuses include motors, for example to operate window treatments.

### BRIEF DESCRIPTION OF THE DRAWINGS

FIG. 1 is a schematic block diagram showing a system for automatically charging devices with and without built-in energy storage.

FIG. 2 is a schematic block diagram of a charging tap used for charging devices with internal energy storage (e.g., batteries or supercapacitors).

FIG. 3 is a schematic block diagram of a charging tap built into a device with internal energy storage.

FIG. 4 is a schematic block diagram of a charging tap used for devices that do not have internal energy storage.

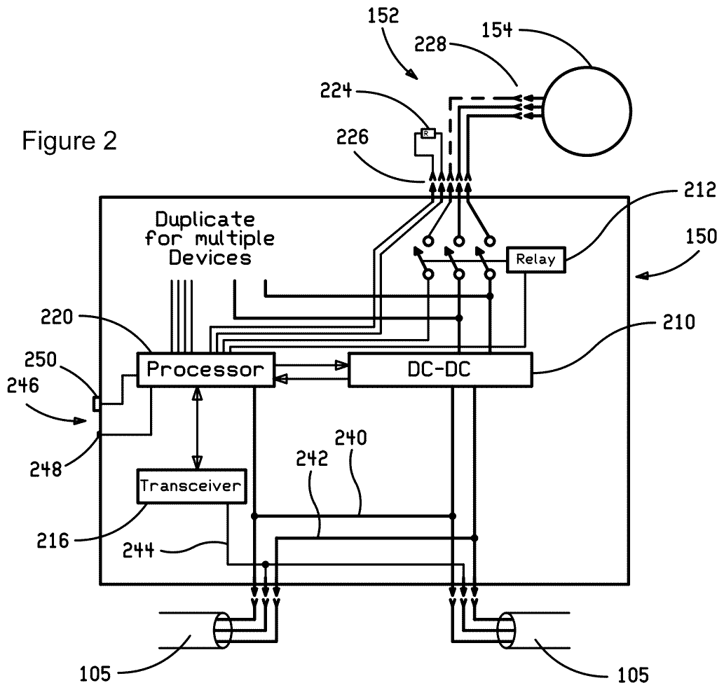

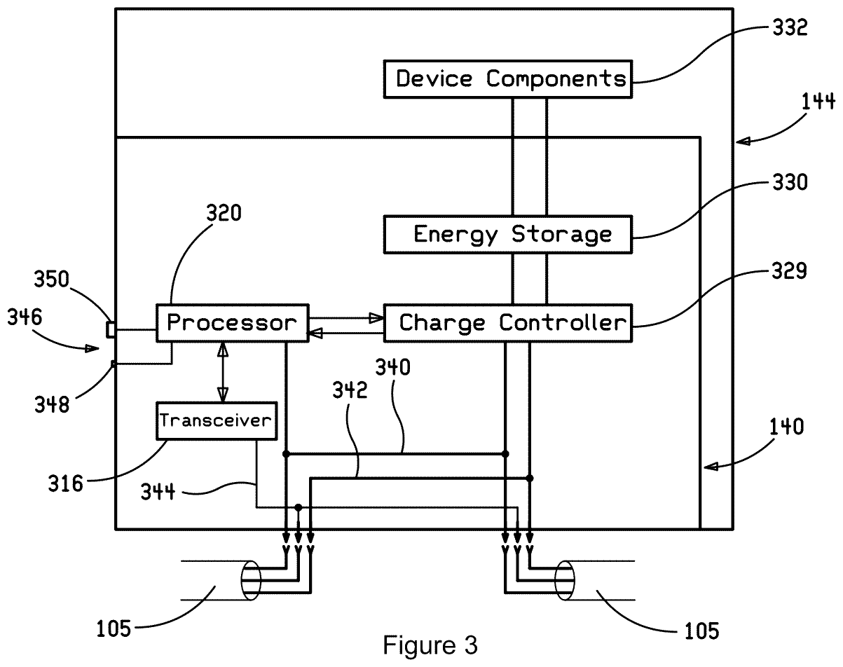

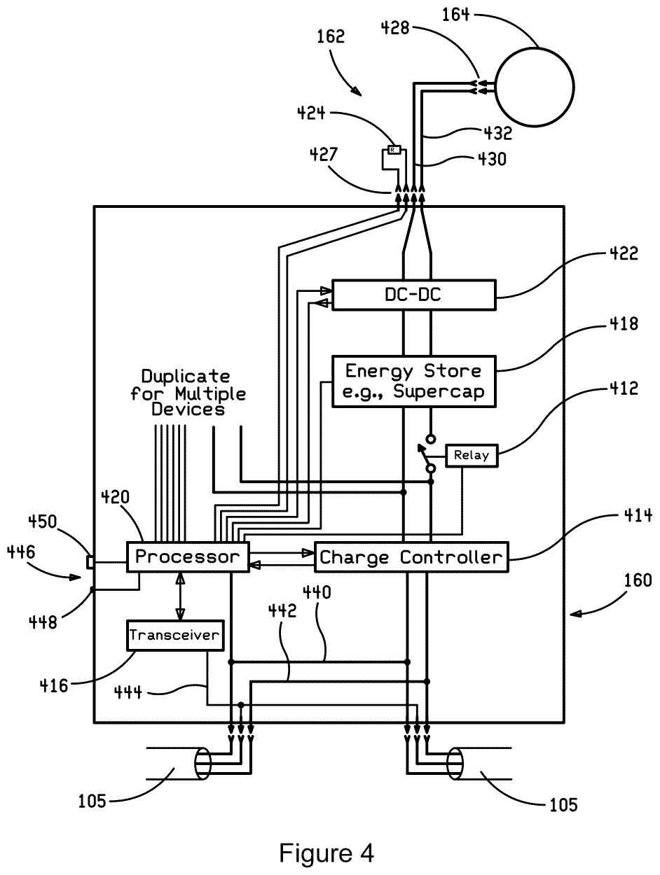

TABLE 1
DETAILED DESCRIPTION OF THE INVENTION

| Reference number | Element |
|---|---|
| 100 | System for charging devices |
| 101 | System power supply |
| 102 | Power hub |
| 105 | Power bus |
| 107 | Splitter |
| 140 | Charging tap built into a device with energy |
| | storage (FIG. 3) |
| 144 | Device with a built-in tap 140 |
| 150 | Charging tap for a device that has energy |
| | storage (FIG. 2) |
| 152 | Connecting cable tap 150 to device 154 |
| 154 | Device with internal energy storage |
| 160 | Charging tap with energy storage for a |
| | plain device (FIG. 4) |
| 162 | Connecting cable tap 160 to device 164 |
| 164 | Plain device (no internal energy storage) |
| 210 | DC to DC converter and current measurement |
| 212 | Relay |
| 216 | Transceiver |
| 220 | Processor |
| 224 | Resistor - part of cable 152 |
| 226 | Connector - connecting cable 152 to charging |
| | tap 150 |
| 228 | Connector - connecting cable 152 to device 154 |
| 240 | Bus negative |
| 242 | Bus positive |
| 244 | Bus signal |
| 246 | User interface |
| 248 | LED |
| 250 | Button |
| 316 | Transceiver |
| 320 | Processor |
| 329 | Charge controller for storage 330 |
| 330 | Built-in Energy Storage for device components 332 |
| 332 | Device components |
| 340 | Bus negative |
| 342 | Bus positive |
| 344 | Bus signal |
| 346 | User interface |
| 348 | LED |
| 350 | Button |
| 412 | Relay |
| 414 | Charge controller for storage 418 |
| 416 | Transceiver |
| 418 | Energy storage device built into tap |
| 420 | Processor |
| 422 | DC to DC converter and current measurement |
| 424 | Resistor - part of cable 162 |
| 427 | Connector - connecting cable 162 to tap 160 |
| 428 | Connector - connecting cable 162 to device 164 |
| 430 | Negative power lead |
| 432 | Positive power lead |
| 440 | Bus negative |
| 442 | Bus positive |
| 444 | Bus signal |
| 446 | User interface |
| 448 | LED |
| 450 | Button |

Table 1 shows reference numbers and their associated elements.

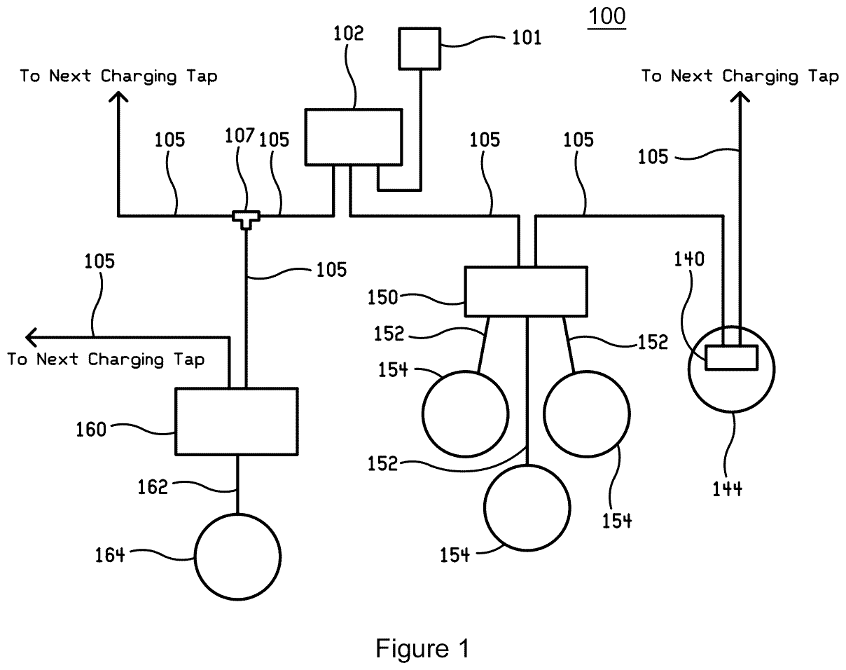

FIG. 1 is a schematic diagram of an example system 100 for automatically charging devices which are spaced apart. FIG. 1 shows a system for automatically combinations of charging devices 144, 154 and 164 via charging taps 140, 150, and 160. Power for the system is provided by power supply 101 drawing from mains power, which connects to power hub 102 which is connected to power bus 105 and provides power to bus 105. Charging taps 140, 150 and 160 connect to power bus 105 and generally are continuously powered.

System 100 may include one or more external charging taps 150 for devices 154 having their own energy storage (see FIG. 2). System 100 may include one or more charging taps 140 which are built into devices 144 which have internal energy storage (see FIG. 3). System 100 may include one or more charging taps 160 which store energy to power devices 164 that do not have their own internal energy storage (see FIG. 4). Or, system 100 may include various other configurations of charging taps. As shown in FIG. 1, different combinations of charging taps 140, 150, 160 can be used by the same system 100, making the system adaptable.

Devices 154 connect to charging taps 150 via connecting cables 152. Each device 154 does have its own energy storage device. Connecting cable 152 is configured to identify the device 154 it is attached to, and delivers the power required by device 154 for charging. See FIG. 2 for a detailed example of charging tap 150.

Charging tap 140 is built into device 144 which has internal energy storage. See FIG. 3 for a detailed example of tap 140.

Device 164 connects to charging tap 160 via connecting cable 162. Device 164 in this example has no internal battery or other energy storage device, so charging tap 160 provides the energy storage capacity. Connecting cable 162 is configured to identify the device 164 it is attached to, and provides the power required by device 164. An example of this configuration is shown in FIG. 4.

Power bus 105 in this example is an at-least-3 conductor cable connected in a daisy-chain, star or combination of these topologies. Splitters 107 may be used to help create star topologies as shown in FIG. 1. If a cable with more conductors is used, the spare conductors will generally be paralleled to reduce resistance and allow longer wires to be used. More conductors may accommodate commonly available wire such as cat5. FIG. 2 is a schematic block diagram of a charging tap 150, attached to a device 154, via connecting cable 152. Device 154 has internal energy storage (not shown). Charging tap 150 includes DC-DC converter with current measuring 210, relay 212, transceiver 216, and processor 220. Power bus 105 provides power and carries a bus signal. In this example, 240 is bus negative, 242 is bus positive, and 244 is signal (optional).

Charging tap 150 uses DC-DC converter 210 to convert voltage from power bus 105 to the voltage needed by device 154 to charge its internal energy storage.

Each connecting cable 152 is configured to identify its particular attached device 154, so the required power is provided to that device 154. In this embodiment, connecting cable 152 includes a resistor 224 which signals the appropriate power to be provided to each device 154 at appropriate intervals to keep the internal storage charged. Device 154 can be various brands with different charging and voltage requirements. Charging tap 150 may be attached to more than one device 154, but generally will only charge one device 154 at a time. This reduces the size of power supply 101 required.

In this example, cable 152 is connected during installation and is not intended to be regularly unplugged. Cable 152 provides two conductors for charging the energy storage in device 154. Connector 228 is configured and selected depending on what brand of device 154 it is being connected to. Connector 226 has multiple pins with a method for identifying which cable 152 is being used and thus determining, for example, what brand and model of device 154 is attached to determine the appropriate voltage and current necessary for charging. There are many ways to achieve this, but this example implementation uses resistor 224 between 2 pins independent of the 2 wires providing power. Processor 220 measures the resistance and sets the output voltage of DC-DC converter 210 before activating optional relay 212 (or equivalent depending on which device is being charged). Relay 212 may be used if it is useful to electrically isolate device 154 from the power bus when it is not being charged.

The dashed line in cable 152 represents possible conductors for feedback from device 154 indicating the state of its internal charge, and possibly other data or control signals. This signaling could be implemented via multiple protocols, with USB being convenient as the connector to many devices is already USB. This signal can be used to stop charging when device 154 is complete. This feedback could also be done via a wireless protocol between the device 154 and the tap 150, or via a bridge device in the hub 102.

FIG. 3 is a schematic block diagram of charging tap 140 built into a device 144 which has internal energy storage 330. The tap 140 includes charge controller 329, transceiver 316, and processor 320. Power bus 105 provides power and carries a bus signal. In this example, 340 is bus negative, 342 is bus positive, and 344 is signal.

Processor 320 uses charge controller 329 to convert voltage from power bus 105 to the voltage needed by energy storage 330. Energy storage 330 provides power to the device components 332 that implement the functions of device 144, e.g., motor, light or sensor.

FIG. 4 is a schematic block diagram of charging tap 160 with energy storage 418 for a plain attached device 164, which does not have internal energy storage, via connecting cable 162. Tap 160 includes charge controller 414, DC-DC converter 422, energy storage 418, relay 412, transceiver 416, and processor 420. Power bus 105 provides power and carries a bus signal. In this example, 440 is bus negative, 442 is bus positive, and 444 is signal (optional).

Tap 160 uses charge controller 414 to convert voltage from power bus 105 to the voltage needed to charge its internal energy storage 418. Tap 160 uses DC-DC converter 422 to convert voltage from energy storage 418 to power device 164 which generally does not have internal energy storage.

Each connecting cable 162 is configured to identify its particular attached device 164, so the required power is provided to that device. In this embodiment, connecting cable 162 includes a resistor 424 which signals the appropriate voltage to be provided to each device 164. Device 164 can be various devices or brands with different voltage requirements. Tap 160 may be attached to more than one device 164.

In this example, cable 162 is connected during installation and is not generally unplugged. Cable 162 provides two conductors 430, 432 for supplying power to device 164. Connector 428 is configured and selected depending on what brand of device 164 it is being connected to. Connector 427 has multiple pins with a method for identifying which cable 162 is being used and thus determining what brand and model of device 164 is attached to determine the appropriate voltage necessary for operation. There are many ways to achieve this, but this example implementation uses resistor 424 between 2 pins independent of the 2 power wires 430, 432. Processor 420 measures the resistance and sets the output voltage of DC-DC converter 422.

Power supply 101 provides sufficient voltage and current to be able to charge any supported brand of device 154, or devices 144 or 164. This actual value depends on how DC-DC converter 210 or 422 or charge controller 329 or 414 is implemented. Generally, only one device is charged at a time, so power supply 101 only needs to be large enough for that demand, plus the small idle current to keep each charging taps 140, 150 or 160 running. Some applications may benefit from powering a few devices at the same time (e.g. two). One particular implementation uses a buck converter, so power supply 101 is 24V 1A which accommodates 16.8V devices at approximately 1A. A buck/boost converter could be used to accommodate higher voltage devices 154, 164.

Charging only one device at a time is accomplished in this example using a busy signal on power bus 105 and taps 140, 150, 160 waiting when bus 105 is busy. An alternative method would be to give each tap 140, 150, 160 a time slot to do its charging. This utilizes a method to synchronize all taps so each one knows when it is their turn.

The batteries in window covering motors are typically Li-ion, but this system can be used to charge any battery type assuming that device 154 (for example) has an appropriate charge controller built in. This system 100 can support solid state batteries or other chemistries as they become available. This system can also allow devices to use supercapacitors for charge storage by decreasing the time between charges appropriately.

Another useful implementation would be to have most of power bus 105 on one type of cable and interconnect with a connection adapter (not shown) to convert to a smaller connector (not shown) used on window covering motors where the motor connector is dual purpose. E.g., a USB C connector on motor 144 could allow the standard USB power pins to be used to charge the motor if it is not connected to power bus 105. Alternate pins on the USB connector could be used when connected to power bus 105. This allows one device to be sold for either use case.

At least two of the bus 105 conductors provide power (240, 242, 340, 342, 440, 442) to taps 140, 150 and 160 and one or more conductors (244, 344, 444) may be used for signaling between the taps and power hub 102. Signaling on power bus 105 may use any existing protocol and transceiver 216, 316, 416, e.g., LIN or RS485, or may use a custom system. This implementation uses a LIN transceiver as it only needs 1 wire and accommodates 24V signaling.

Alternately transceiver 216, 316, 416 could be wireless. This would reduce the required number of wires to two.

In some embodiments, processor 220, 320, 420 has a timer (not shown, preferably kept in non-volatile memory to survive power outages) for each connected device to be charged 144, 154, 160 and internal energy storage 330, 418. When that timer expires (for example every 3 months), Processor 220, 320, 420 determines if the bus 105 is free to use to charge. Determination of busy can be accomplished with messages using a multidrop protocol, or some custom protocol.
If bus 105 is in use, then processor 220, 320, 420 will wait until the bus is idle.
If bus 105 is idle, then processor 220, 320, 420 will mark bus 105 as busy, and then apply power to the device 154 or internal energy storage 330, 418 that timed out as described earlier. Generally, it also starts a maximum charge timer.

As an example, refer to FIG. 2. Processor 220 in tap 150 checks the amount of current being sourced by DC-DC converter 210, and will remove power if device 154 stops drawing current because it is sufficiently charged, or if the maximum charge timer runs out. Then processor 220 assumes that device 154 is charged, and resets the timer for the next charge (typically 3 months). Taps 140 or 160 have built-in energy storage 330, 418, so can easily determine state of charge and handle recharging based on that rather than the simple timer.

The optional user interface 246, 346, 446 including for example button 250, 350, 450 and LED 248, 348, 448 shown may be used to administer intervals, to check times till next charge, to cause immediate charge cycle when needed, and to aid in installation.

Multiple taps with internal energy storage 160 or without 150 or built in 140 may all be on power bus 105 simultaneously and the system will generally only charge one device 154 or one internal energy storage element 418 or 330 at a time.

Many variations and alternate implementations fall within the spirit of this invention.

Supercapacitors are generally not currently used to power motors in stand-alone window motor applications because they self-discharge and the user would be charging them way too often to be practical. Charging tap 150 at short intervals overcomes this problem and can allow a motor manufacturer to use supercapacitors inside their motor.

The bus signal 244, 344, 444 on Power bus 105 could be extended to include messages for controlling the device or data collection.

While the exemplary preferred embodiments of the present invention are described herein with particularity, those skilled in the art will appreciate various changes, additions, and applications other than those specifically mentioned, which are within the spirit of this invention. For example, if the busy signal is sent wirelessly, the power hub may be a simple connector block.

What is claimed is:

1. A system for automatically charging spaced-apart energy storage devices comprising:
a power hub connected to a system power supply;
a plurality of energy storage devices to be charged, the energy storage devices spaced apart from each other;
a bus for distributing power from the power hub;
charging taps located at the energy storage devices and connected to the bus and to the energy storage devices, the charging taps configured to draw power from the bus and to charge the energy storage devices;
wherein each charging tap includes a processor including a timer configured to determine when an associated energy storage device is to be charged; and
wherein the system is configured such that only a subset of the energy storage devices is charged at the same time.

2. The system of claim 1 wherein only one energy storage device is charged at a time.

3. The system of claim 1 wherein some energy storage devices and charging taps are built into spaced-apart apparatuses.

4. The system of claim 3 further comprising an identifying mechanism connected to each built-in energy storage device to determine the power requirements of that built in energy storage device.

5. The system of claim 1 wherein some energy storage devices are located within charging taps and wherein apparatuses are powered by those charging taps.

6. The system of claim 5 further comprising an identifying mechanism connected to each energy storage device configured to determine the power requirements of that energy storage device.

7. The system of claim 1 wherein some energy storage devices are located within apparatuses discrete from charging taps.

8. The system of claim 7 further comprising an identifying mechanism connected to each apparatus configured to determine the power requirements of the energy storage device within the connected apparatus.

9. The system of claim 8 wherein the charging taps provide power configured according to associated identifying mechanisms.

10. The system of claim 7 wherein the processors further include a bus-check mechanism configured to check whether the bus is in use when a timer indicates an energy storage device is to be charged, and to delay charging that energy storage device if the bus is in use.

11. The system of claim 10 wherein each timer has a programmed time slot and wherein an associated energy storage device is charged during that time slot.

12. The system of claim 7 wherein each charging tap is connected to only one or two apparatuses.

13. The system of claim 1 wherein the energy storage devices comprise batteries.

14. The system of claim 1 wherein the energy storage devices comprise capacitors.

15. The system of claim 1 wherein the apparatuses include motors.

16. The system of claim 15 wherein the motors operate window treatments.

17. The system of claim 1 where the energy storage devices are not all similarly configured.

18. The system of claim 1 wherein the processors further include a bus-check mechanism configured to check whether the bus is in use when a timer indicates an energy storage device is to be charged, and to delay charging that energy storage device if the bus is in use.

19. The system of claim 18 wherein each timer has a programmed time slot and wherein an associated energy storage device is charged during that time slot.
